(19) United States
(12) Patent Application Publication
(10) Pub. No.: US 2025/0211052 A1
(43) Pub. Date: Jun. 26, 2025

(54) ELECTRICAL MACHINE SYSTEM AND MOBILITY DEVICE COMPRISING SUCH AN ELECTRICAL MACHINE SYSTEM

(71) Applicant: Valeo eAutomotive Germany GmbH, Erlangen (DE)

(72) Inventors: Diego SCHIERLE, Erlangen (DE); Oliver DEHM, Erlangen (DE); Christian MEDING, Erlangen (DE)

(73) Assignee: Valeo eAutomotive Germany GmbH, Erlangen (DE)

(21) Appl. No.: 18/984,093

(22) Filed: Dec. 17, 2024

(30) Foreign Application Priority Data
Dec. 20, 2023 (DE) 102023136114.7

(51) Int. Cl. H02K 5/10; H02K 3/50; H02K 11/33

(52) U.S. Cl. CPC H02K 5/10; H02K 3/50; H02K 11/33; H02K 2203/09

(57) ABSTRACT

An electrical machine system includes an electrical machine, an inverter, and a wall with a hole. The electrical machine and the inverter extend respectively on two sides of the wall. Several busbars connect the electrical machine and the inverter, at least one of the busbars includes a first portion extending on the side of the electrical machine, a second portion extending on the side of the inverter, and a rigid central portion connecting the first and second portions, the central portion going through the hole of the wall. At least one of the first portion and the second portion includes a braided portion and a sealing device between the wall and the central portion of the busbar.

### TECHNICAL FIELD

The present invention relates to an electrical machine system and a mobility device comprising such an electrical machine system.

The invention may in particular be used in a mobility device. A mobility device is for example a motorized land vehicle, a train, an aircraft or even a drone. A motorized land vehicle is for example a motor vehicle, a motorcycle, a motorized bicycle or a motorized wheelchair.

### BACKGROUND ART

An electrical machine system comprises an electrical machine and an inverter, connected to each other by several busbars. It is known to use a single common casing for both the electrical machine and the inverter. However, they are usually positioned in two separate compartments of the casing. The two compartments need to be hermetically sealed from each other because of different requirements needed for each of them. For example, level of humidity or cleanliness requirement can be different for the inverter and for the electrical machine.

It is therefore necessary to pass the busbars through the wall separating the two compartments. However, the relative position of the electrical machine and the inverter may be different from what was designed due to manufacturing tolerance and/or may change during functioning due to thermo-expansion resulting from the difference of temperature between the two compartments.

The invention aims to overcome at least part of the preceding problems.

### DISCLOSURE OF THE INVENTION

The invention relates to an electrical machine system comprising:
an electrical machine; and
an inverter;
a wall with a hole, the electrical machine and the inverter extending respectively on two sides of the wall;
several busbars connecting the electrical machine and the inverter, at least one of the busbars comprising a first portion extending on the side of the electrical machine, a second portion extending on the side of the inverter, and a rigid central portion connecting the first and second portions, the central portion going through the hole of the wall; at least one of the first portion and the second portion comprises a braided portion and
a sealing device between the wall and the central portion of the busbar.

Thanks to the invention, the busbar is able to compensate the change of relative position, while still maintaining the two compartment hermetically sealed. Having both compartment hermetically sealed allow to ensure that components are working properly and respects the specific requirement of each component separately. For example to ensure that no transfer of a cooling fluid of the electrical machine to a dry inverter cavity can occurs.

In particular, the sealing can be effective thanks to the rigid central portion.

The invention may also include one or more of the following optional features, in any technically possible combination.

Optionally, the first portion and the second portion comprise a braided portion, the central portion connecting the first and second braided portions.

Also optionally the sealing device comprises: —a sleeve surrounding the central portion of the busbar, the sleeve covering the hole of the wall; —a sealing ring extending between the sleeve and the wall, the sealing ring surrounding the hole of the wall; and—a pushing device configured for pushing the sleeve towards the wall so that the sleeve squeezes the sealing ring.

Also optionally, the sleeve extends on the inverter side of the wall.

Also optionally, the pushing device comprises at least one screw passing trough the sleeve and screwed into the wall.

Also optionally, the sealing device comprises a sealing ring inserted between the central portion of the busbar and the wall.

Also optionally, the electrical machine system comprises a casing defining an inside space, the wall separating the inside space into two compartments, the electrical machine extending in the first compartment, the inverter extending in the second compartment.

Also optionally, the busbar is made of copper.

The invention also relates to a mobility device comprising an electrical machine system according to the invention.

### BRIEF DESCRIPTION OF THE DRAWINGS

The invention will be better understood with the help of the description which follows, given solely by way of example and made with reference to the appended drawings in which:

FIG. 1 is schematic view of a first example of electrical machine system according to the invention, and

FIG. 2 is schematic view of a second example of electrical machine system according to the invention.

### DETAILED DESCRIPTION

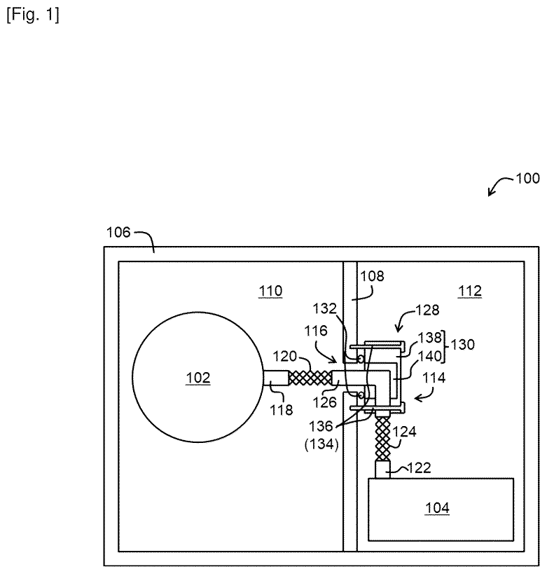

Referring to FIG. 1, an electrical machine system 100 according to the invention will now be described. The electrical machine system 100 is for example designed to be used in a mobility device.

The electrical machine system 100 first comprises an electrical machine 102 having several phases. The electrical machine 102 can function as a motor and/or as a generator.

The electrical machine system 100 further comprises an inverter 104 designed for providing phase voltages U, V, W from a DC voltage source (not depicted).

The electrical machine system 100 further comprises a casing 106 defining an inside space, and a wall 108 separating the inside space into two compartments 110, 112. The electrical machine 102 and the inverter 104 extend respectively on two sides of the wall 108. More precisely, the electrical machine 102 extends in the first compartment 110 and the inverter 104 extends in the second compartment 112.

The electrical machine system 100 further comprises several busbars, only one being depicted on FIG. 1 and referenced 114. The busbars 114 connect the inverter 104 to respectively the phases of the electrical machine 102, in order to respectively convey the phase voltages U, V, W between the inverter 104 and respectively the phases of the electrical machine 102.

In order to let the busbar 114 pass through the wall 108, the wall 108 is provided with a hole 116.

The busbar 114 comprises, in the first compartment 110, a first rigid connection portion 118 connected to the electrical machine 102 and a first flexible braided portion 120 connected to the first rigid connection portion 118.

Similarly, the busbar 114 comprises, in the second compartment 112, a second rigid connection portion 122 connected to the inverter 104 and a second flexible braided portion 124 connected to the second rigid connection portion 122.

The busbar 114 further comprises a rigid central portion 126 connecting the first and second braided portions 120, 122, the rigid central portion 126 going through the hole 116 of the wall 108. The rigid portions 118, 122, 126 are preferably solid, i.e. not hollow.

The electrical machine system 100 further comprises a sealing device 128 between the wall 108 and the central portion 126 of the busbar 114.

For example, as depicted, the sealing device 128 comprises a sleeve 130 surrounding the central portion 126 of the busbar 114. The sleeve 130 is configured to be watertight to prevent liquid such as water to propagate from one of the compartments 110, 112 to the other along the central portion 126 of the busbar 114.

In order to also prevent propagation of liquid such as water around the sleeve 130, the sleeve 130 is positioned to cover the hole 116 of the wall 108 and the sealing device 128 further comprises a sealing ring 132 inserted between the sleeve 130 and the wall 108, the sealing ring 132 surrounding the hole 116 of the wall 108. The sealing ring 132 is configured to be watertight to prevent liquid from passing between the wall 108 and the sleeve 130. The sealing device 128 then further comprises a pushing device 134 configured for pushing the sleeve 130 towards the wall 108 so that the sleeve 130 squeezes the sealing ring 132 against the wall 108. For example, as depicted, the pushing device 134 comprises one or several screws 136 passing through the sleeve 130 and screwed in the wall 108.

In some embodiments, the sleeve 130 comprises a single overmolding around the central portion 126 of the busbar 114.

In some embodiments, as depicted, the sleeve 130 comprises a first overmolding 138 around the central portion 126 of the busbar 114 and a second overmolding 140 around the first overmolding 138. For example, the first overmolding is made of a soft material and the second overmolding is made of a hard material. The hard overmolding material is used for fixation and structural rigidity and the softer material is used to ensure tightness during thermal expansion so that the elastic material can follow the deformation of the busbars.

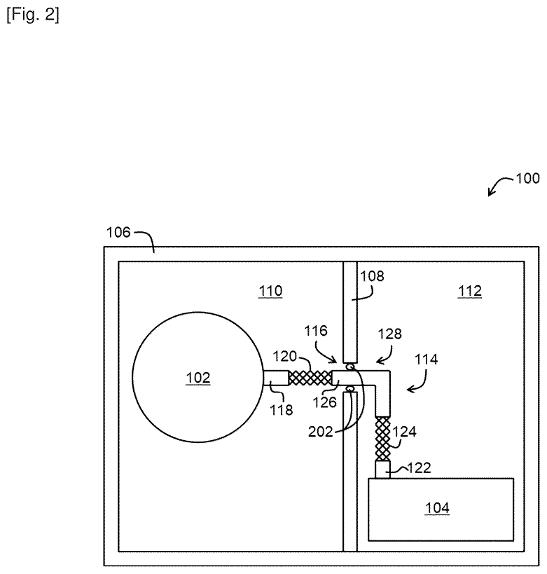

Referring to FIG. 2, in some embodiments, the sealing device 128 comprises a sealing ring 202 inserted between the wall 108, for example, as depicted, an edge (i.e. a width) of the wall around the rim of the hole 116, and the central portion 126 of the busbar 114.

The busbar(s) other than the busbar 114 may have the same structure than the busbar 114, as described above. All the busbars 114 may pass trough respective holes in the wall 108, or trough the same hole, in which case all the busbars 114 may be surrounded by a same single sleeve.

In conclusion, it should be noted that the invention is not limited to the embodiments described above. It will indeed appear to those skilled in the art that various modifications can be made to the embodiments described above, in light of the teaching which has just been disclosed to him.

In the detailed presentation of the invention which is made previously, the terms used should not be interpreted as limiting the invention to the embodiments set out in the present description, but must be interpreted to include all the equivalents for which the prediction is within the reach of those skilled in the art by applying their general knowledge to the implementation of the teaching which has just been disclosed to them.

1. Electrical machine system comprising:
an electrical machine;
an inverter;
a wall with a hole, the electrical machine and the inverter extending respectively on two sides of the wall;
several busbars connecting the electrical machine and the inverter, at least one of the busbars comprising a first portion extending on the side of the electrical machine, a second portion extending on the side of the inverter, and a rigid central portion connecting the first and second portions, the central portion going through the hole of the wall; at least one of the first portion and the second portion comprises a braided portion and
a sealing device between the wall and the central portion of the busbar.

2. Electrical machine system according to claim 1, wherein the first portion and the second portion comprise a braided portion, the central portion connecting the first and second braided portions.

3. Electrical machine system according to claim 1, wherein the sealing device comprises:
a sleeve surrounding the central portion of the busbar, the sleeve covering the hole of the wall;
a sealing ring extending between the sleeve and the wall, the sealing ring surrounding the hole of the wall; and
a pushing device configured for pushing the sleeve towards the wall so that the sleeve squeezes the sealing ring.

4. Electrical machine system according to claim 3, wherein the sleeve extends on the inverter side of the wall.

5. Electrical machine system according to claim 3, wherein the pushing device comprises at least one screw passing through the sleeve and screwed into the wall.

6. Electrical machine system according to claim 1, wherein the sealing device comprises a sealing ring inserted between the central portion of the busbar and the wall.

7. Electrical machine system according to claim 1, further comprises a casing defining an inside space, the wall separating the inside space into two compartments, the electrical machine extending in the first compartment, the inverter extending in the second compartment.

8. Electrical machine system according to claim 1, wherein the busbar is made of copper.

9. Mobility device comprising an electrical machine system according to claim 1.

10. Electrical machine system according to claim 2, further comprises a casing defining an inside space, the wall separating the inside space into two compartments, the electrical machine extending in the first compartment, the inverter extending in the second compartment.

11. Electrical machine system according to claim 2, wherein the busbar is made of copper.

12. Mobility device comprising an electrical machine system according to claim 2.

13. Electrical machine system according to claim 3, further comprises a casing defining an inside space, the wall separating the inside space into two compartments, the electrical machine extending in the first compartment, the inverter extending in the second compartment.

14. Electrical machine system according to claim 3, wherein the busbar is made of copper.

15. Mobility device comprising an electrical machine system according to claim 3.

16. Electrical machine system according to claim 4, further comprises a casing defining an inside space, the wall separating the inside space into two compartments, the electrical machine extending in the first compartment, the inverter extending in the second compartment.

17. Electrical machine system according to claim 4, wherein the busbar is made of copper.

18. Mobility device comprising an electrical machine system according to claim 4.

19. Electrical machine system according to claim 5, further comprises a casing defining an inside space, the wall separating the inside space into two compartments, the electrical machine extending in the first compartment, the inverter extending in the second compartment.

20. Electrical machine system according to claim 5, wherein the busbar is made of copper.
